(19) United States
(12) Patent Application Publication
(10) Pub. No.: US 2018/0202188 A1
(43) Pub. Date: Jul. 19, 2018

(54) T-shaped Post Driver

(71) Applicant: Larry D. Dishman, Grand Island, NE (US)

(72) Inventor: Larry D. Dishman, Grand Island, NE (US)

(21) Appl. No.: 15/873,708

(22) Filed: Jan. 17, 2018

Related U.S. Application Data
(60) Provisional application No. 62/447,767, filed on Jan. 18, 2017.

(51) Int. Cl. E04H 17/26

(52) U.S. Cl. CPC E04H 17/263; B25D 1/00

(57) ABSTRACT

A T-shaped post driver includes a driver, a first handle, a second handle. The driver is a tubular body that includes an opened end and a closed end. The first handle and the second handle are laterally connected to the tubular body and diametrically opposed of each other. This maximizes the distance between the left hand and the right hand of a user as the T-shaped post driver is utilized to drive smaller diameter or circumference posts that fits into the tubular body. The T-shaped post driver is also covered with a protective coating to keep outside elements reacting with the driver, the first handle, and the second handle.

The current application claims a priority to the U.S. Provisional Patent application Ser. No. 62/447,767 filed on Jan. 18, 2017.

### FIELD OF THE INVENTION

The present invention relates generally to an apparatus for stake driving. More specifically, the present invention is a device used to drive smaller diameter stakes into the ground without compromising the structural integrity of the stakes.

### BACKGROUND OF THE INVENTION

A post driver, also known as a post pounder, a post knocker, or a fence driver, is a tool utilized for driving fence post of similar items into the ground. Even though there are many different post drivers available to consumers, these different post drivers are designed towards the commercial application and not towards the household application. Additionally, existing post drivers generally requires additional mechanical tools, such as pile drivers and gas-powered post drivers, due to the weight and large structure of post drivers. As a result, there is a greater need for light weight and smaller post drivers that can be utilized within household application such as putting up a gardening fence, a flowerbed fence, and any other household application.

It is an objective of the present invention to provide a light weight and small T-shaped post driver in order to drive smaller posts that are generally utilized within household fencing. More specifically, the present invention is an apparatus that is used to drive smaller diameter stakes into the ground in which minimize personal injuries to user and damages to the structural integrity of driven stakes that can cause by using bulky post drivers.

### BRIEF DESCRIPTION OF THE DRAWINGS

FIG. 1 is a top perspective view of the present invention.

FIG. 2 is a bottom perspective view of the present invention.

FIG. 3 is a top view of the present invention showing the diametrically opposed first handle and the second handle.

FIG. 4 is a front view of the present invention showing the inner diameter of the tubular body.

FIG. 5 is a front view of the present invention showing the length of the tubular body.

FIG. 6 is a front view of the present invention showing different lengths of the straight arm section, the angular arm section, and the connector arm section for the first handle and the second handle.

FIG. 7 is a front view of the present invention showing the acute angle between the straight arm section and the angular arm section for the first handle and the second handle.

FIG. 8 is a front cross-sectional view of the present invention showing the protective coating.

### DETAIL DESCRIPTIONS OF THE INVENTION

All illustrations of the drawings are for the purpose of describing selected versions of the present invention and are not intended to limit the scope of the present invention.

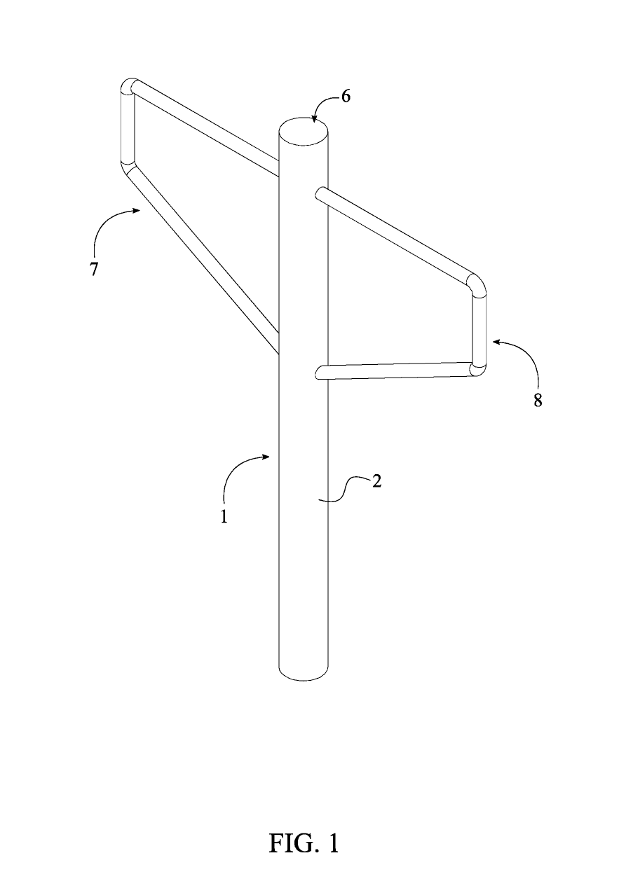

The present invention is a T-shaped post driver that is used to drive smaller diameter stakes into the ground. More specifically, the present invention is preferably utilized within household applications such as putting up gardening fence, a flowerbed fence, any other types of fences that use smaller diameter stakes. As a result, the present invention is able to eliminate cumbersome post drivers that are typically used for driving bulky fence posts. The present invention comprises a driver 1, a first handle 7, a second handle 8 as show in FIG. 1. In reference to the general configuration of the present invention, the first handle 7 and the second handle 8 are oppositely positioned of each other and connected to the driver 1 so that the driver 1 can be intermittently pressed against a top end of the stake to drive in the stake to the ground.

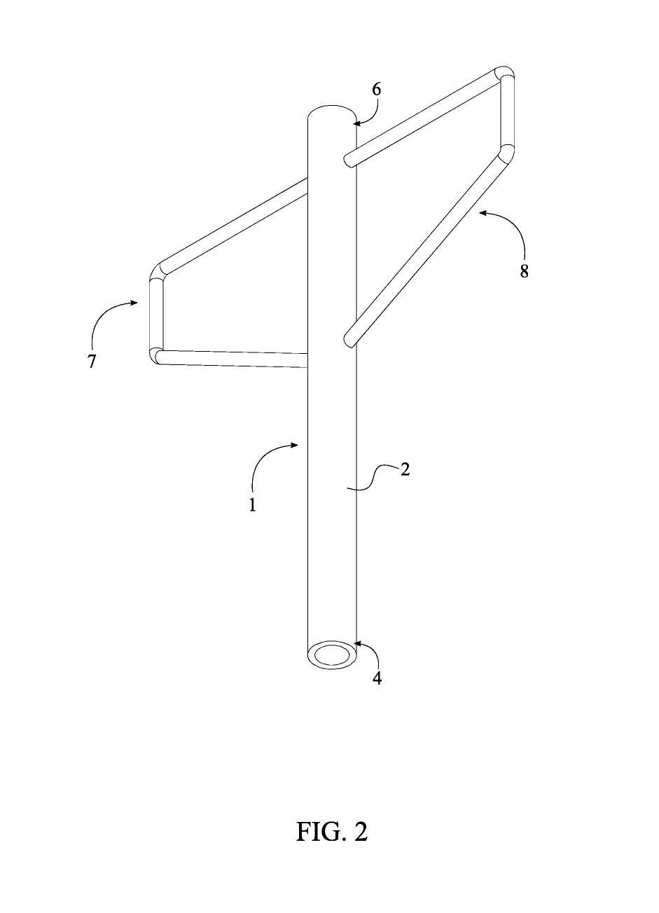

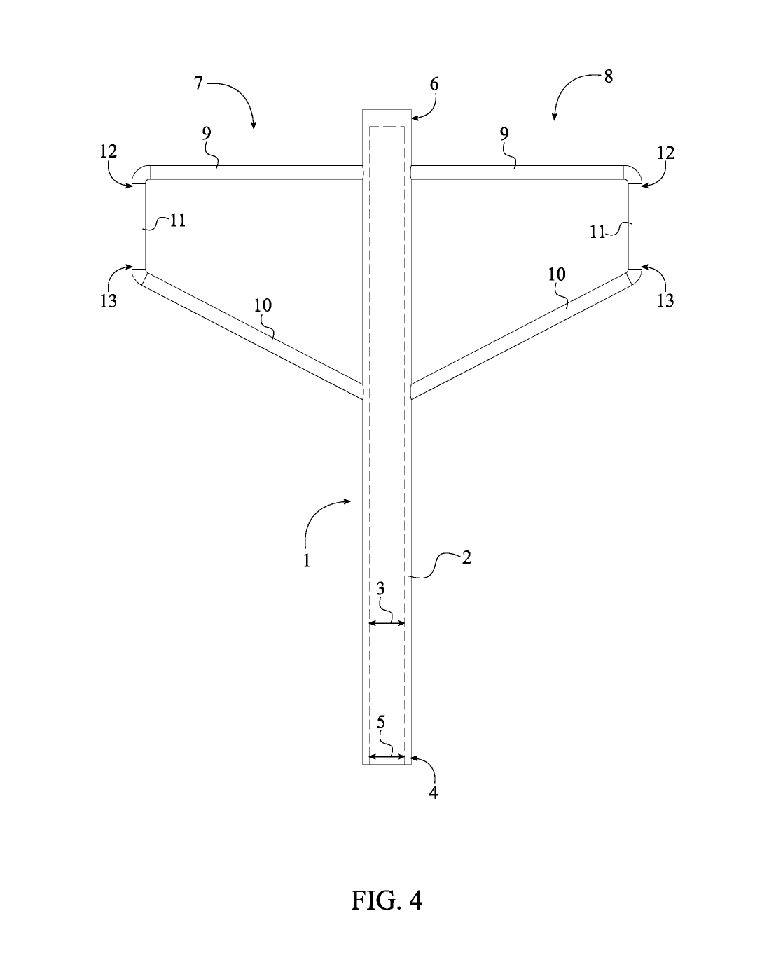

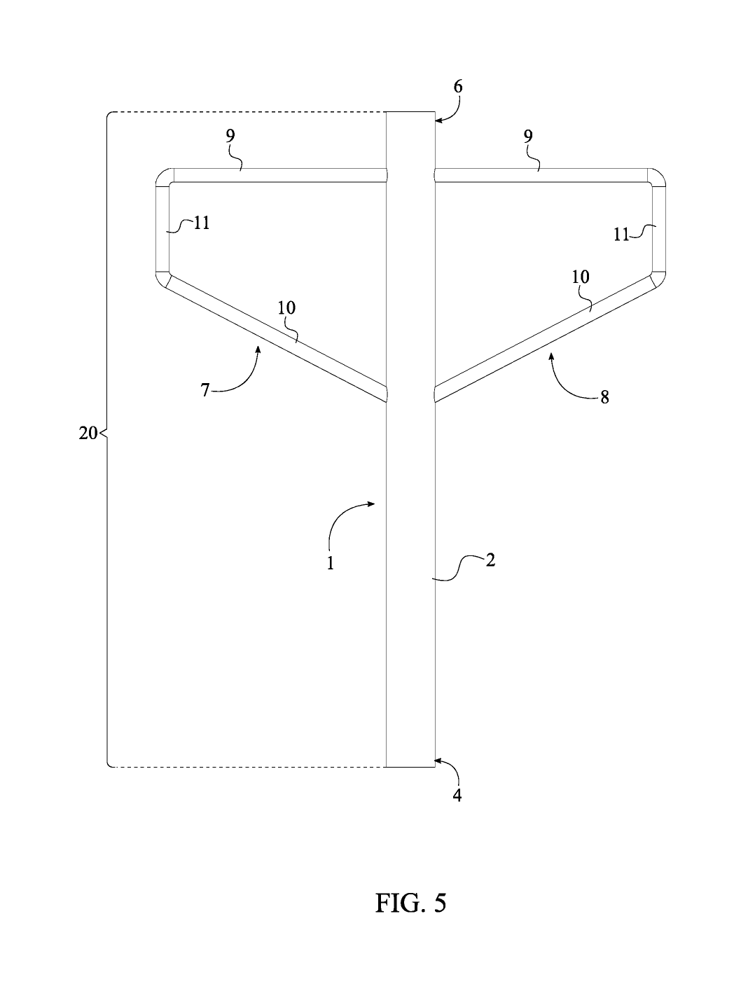

The driver 1, which functions as the hammering component within the present invention, comprises a tubular body 2, an opened end 4, and a closed end 6 as shown in FIG. 1-2. The opened end 4 and the closed end 6 are oppositely positioned of each other along the tubular body 2. Additionally, the tubular body 2, the opened end 4, and the closed end 6 are concentrically positioned of each other thus delineating a straight and elongated tube-like body for the driver 1. As a result, the top end of the stake can be inserted into the tubular body 2 through the opened end 4 until the closed end 6 comes into the contact with the top end of the stake. In reference to FIG. 5, a length 20 of the driver 1 then allows a user to keep the stake within the tubular body 2 while enabling the driver 1 to move up and down along the top end of the stake and apply pressure through the closed end 6. More specifically, an inner diameter 3 of the tubular body 2 ranges between 0.6875 inches to 0.8125 inches in order to accommodate the smaller diameter of the stake. Preferably, the inner diameter 3 of the tubular body 2 is approximately 0.75 inches so that a preferred embodiment of the present invention can only be utilized against stakes that have a diameter less than 0.75 inches. In order to properly place the present invention around the stake, the inner diameter 3 of the tubular body 2 and an inner diameter 5 of the opened end 4 are configured to be equal to each other within the driver 1 as shown in FIG. 4. In reference to the preferred embodiment of the present invention, the length 20 of the driver 1 is measured to be 14.25 inches and the closed end 6 is measured to be 0.375 inches. The driver 1 is preferably made of steel or any other types of rigid material that can withstand hammering of the present invention.

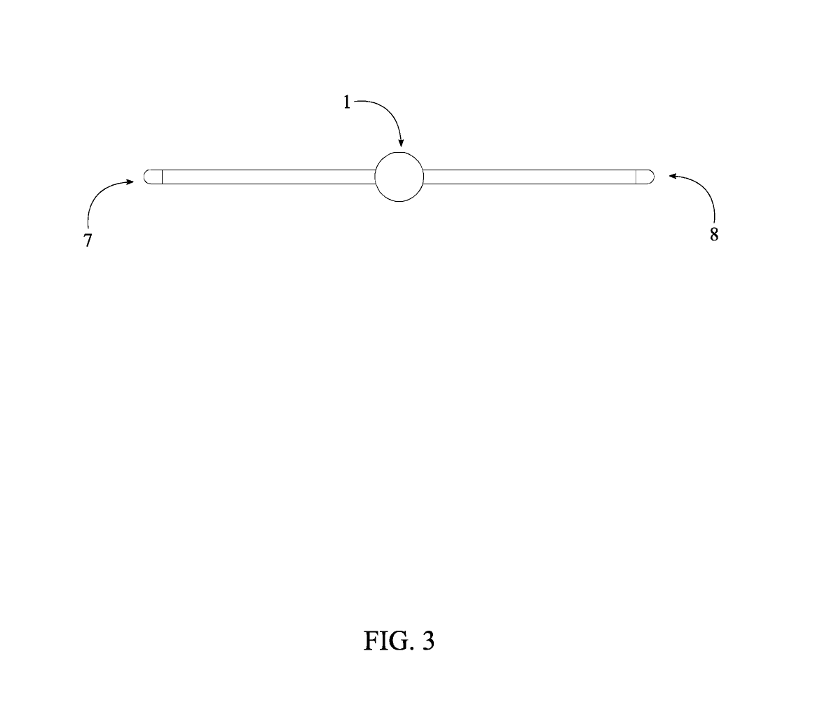

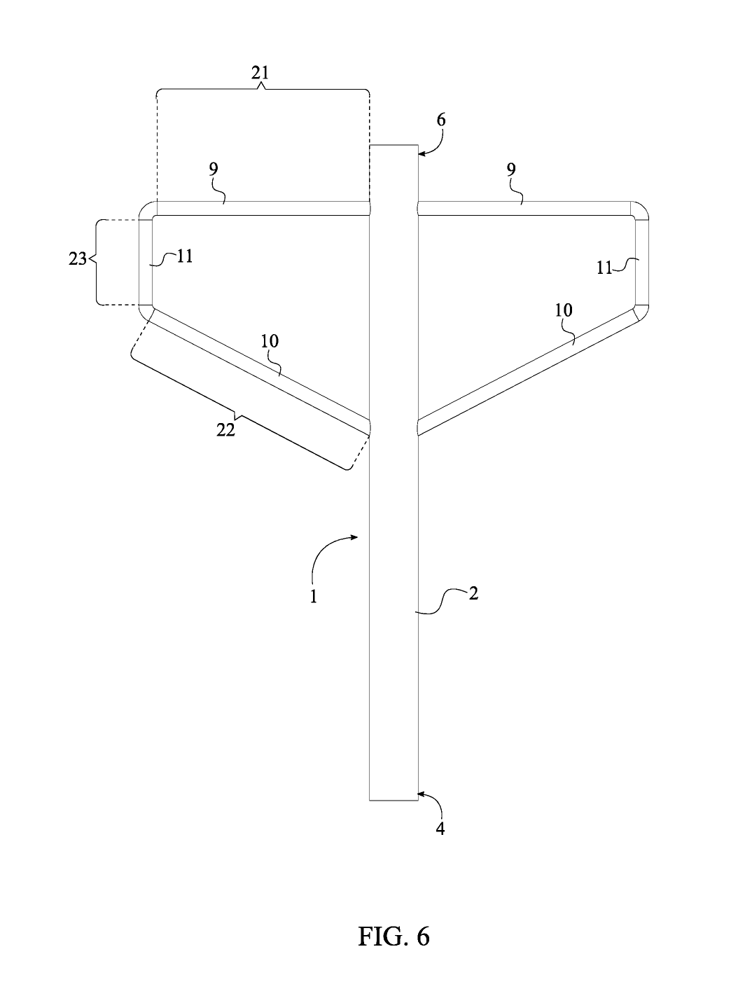

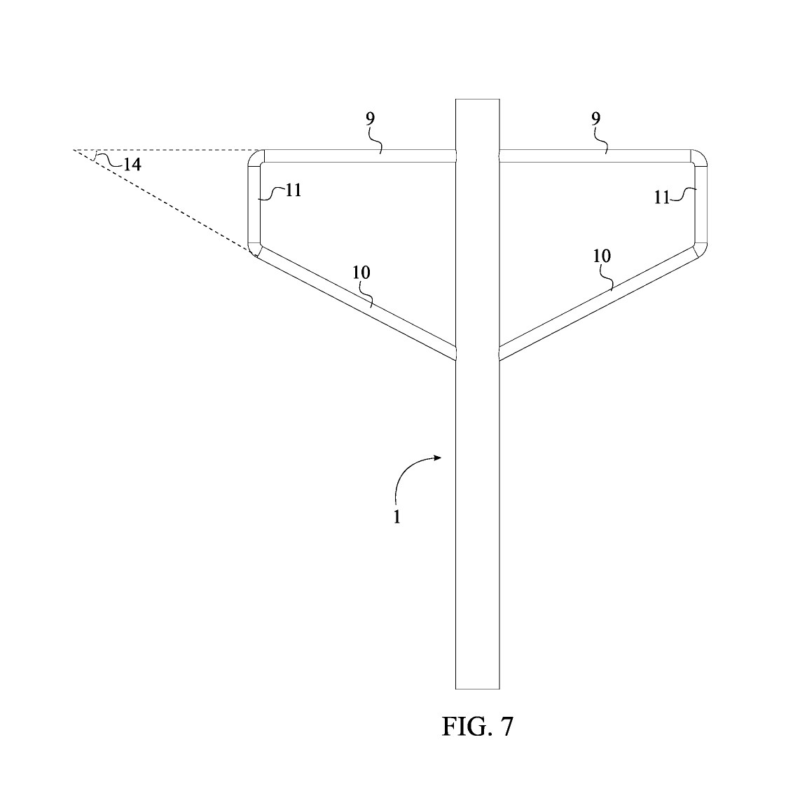

The first handle 7 and the second handle 8 allow the user to securely hold the present invention during the usage. The first handle 7 and the second handle 8 are laterally connected to the tubular body 2 and diametrically opposed of each other about the tubular body 2 as shown in FIG. 3. Due to the diametric positioning of the first handle 7 and the second handle 8, the present invention is able to maximize the distance between the left hand and the right handle of the user. As a result, when the stake is forced into the ground, the user is able to comfortably grip the present invention through the first handle 7 and the second handle 8 and keep both hands away from any contact points between the driver 1 and the stake that can create personal injuries. In reference to FIG. 4-7, the first handle 7 and the second handle 8 each comprise a straight arm section 9, an angular arm section 10, and a connector arm section 11. More specifically, the straight arm section 9 is terminally connected to the tubular body 2 in such a way that the straight arm section 9 is positioned perpendicular to the tubular body 2 and adjacently positioned to the closed end 6. An upper end 12 of the connector arm section 11 is terminally connected to the straight arm section 9, wherein the connector arm section 11 is positioned parallel to the tubular body 2. The angular arm section 10 is terminally connected to a lower end 13 of the connector arm section 11 and the tubular body 2 at an angle 14 such that the angle 14 is defined as an acute angle 14 between the straight arm section 9 and the angular arm section 10. In reference to the preferred embodiment of the present invention, a length 21 of the straight arm section 9 is measured to be 4.875 inches, a length 23 of the connector arm section 11 is measured to be 2.25 inches, and a length 22 of the angular arm section 10 is measured to be 5.5 inches. The first handle 7 and the second handle 8 are preferably made of steel or any other types of rigid material that can withstand pressure applied by the user during usage of the present invention.

In order to securely grab the first handle 7 and the second handle 8 during usage, a ratio between the length 21 of the straight arm section 9 and the length 20 of the tubular body 2 is approximately 1:3. Furthermore, a ratio between the length 23 of the connector arm section 11 and the length 20 of the tubular body 2 is approximately 3:19. Optionally, the first handle 7 and the second handle 8 may each comprise a grip so that the user contact points between the first handle 7 and the second handle 8 can prevent accidental slippage of the present invention.

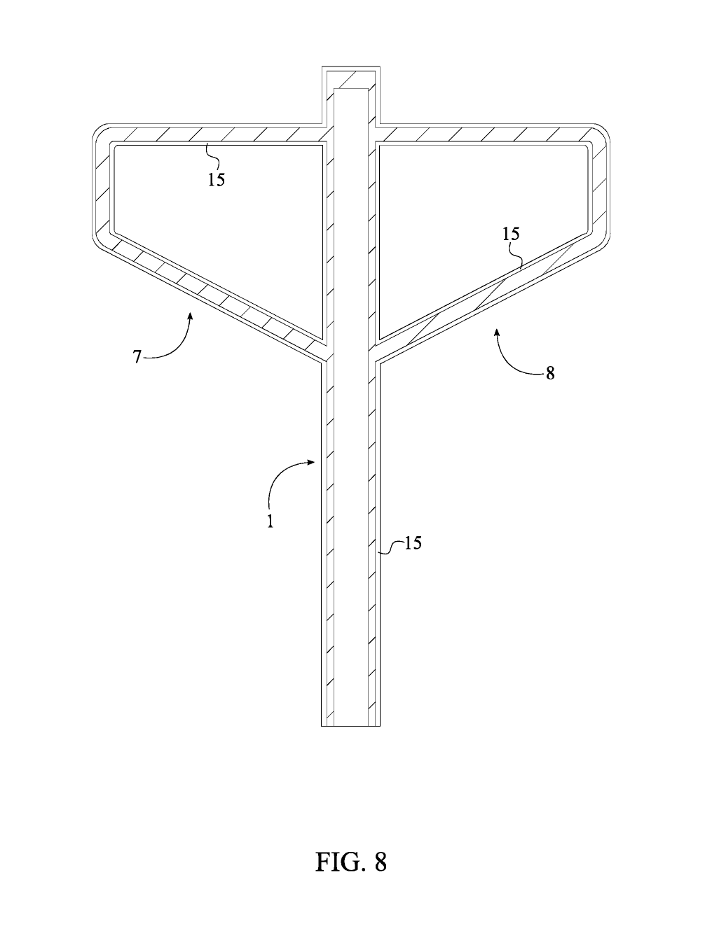

In reference to FIG. 8, the present invention further comprises a protective coating 15. The protective coating 15 is externally superimposed over the tubular body 2, the first handle 7, and the second handle 8 so that the present invention can be protected from corrosive outside elements thus improving the reliability.

Although the invention has been explained in relation to its preferred embodiment, it is to be understood that many other possible modifications and variations can be made without departing from the spirit and scope of the invention as hereinafter claimed.

What is claimed is:

1. A T-shaped post driver comprises:
a driver;
a first handle;
a second handle;
the driver comprises a tubular body, an opened end, and a closed end;
the opened end and the closed end being oppositely positioned of each other along the tubular body;
the tubular body, the opened end, and the closed end being concentrically positioned of each other;
the first handle and the second handle being laterally connected to the tubular body;
the first handle and the second handle being diametrically opposed of each other about the tubular body; and
an inner diameter of the tubular body being ranged between 0.6875 inches to 0.8125 inches.

2. The T-shaped post driver as claimed in claim 1 comprises:
the first handle and the second handle each comprise a straight arm section, an angular arm section, and a connector arm section;
the straight arm section being terminally connected to the tubular body;
the straight arm section being adjacently positioned to the closed end;
an upper end of the connector arm section being terminally connected to the straight arm section; and
the angular arm section being terminally connected to a lower end of the connector arm section and the tubular body at an angle.

3. The T-shaped post driver as claimed in claim 3, wherein straight arm section is positioned perpendicular to the tubular body.

4. The T-shaped post driver as claimed in claim 3, wherein the connector arm section is positioned parallel to the tubular body.

5. The T-shaped post driver as claimed in claim 3, wherein the angle is an acute angle between the straight arm section and the angular arm section.

6. The T-shaped post driver as claimed in claim 3, wherein a ratio between a length of the straight arm section and a length of the tubular body is approximately 1:3.

7. The T-shaped post driver as claimed in claim 3, wherein a ratio between a length of the connector arm section and a length of the tubular body is approximately 3:19.

8. The T-shaped post driver as claimed in claim 1, wherein the inner diameter of the tubular body is approximately 0.75 inches.

9. The T-shaped post driver as claimed in claim 1, wherein the inner diameter of the tubular body is equal to an inner diameter of the opened end.

10. The T-shaped post driver as claimed in claim 1 comprises:
a protective coating; and
the protective coating being externally superimposed over the tubular body, the first handle, and the second handle.
